(19) United States
(12) Patent Application Publication
(10) Pub. No.: US 2011/0113166 A1
(43) Pub. Date: May 12, 2011

(54) Method and Apparatus of USB 3.0 Based Computer, Console and Peripheral Sharing

(75) Inventors: Patrick Siu-Ying Hung, Saratoga, CA (US); Toshimi Sakurai, Shizuoka (JP); Patrick Wai-Wah Fung, San Jose, CA (US)

(73) Assignee: CPO Technologies Corporation, Sunnyvale, CA (US)

(21) Appl. No.: 12/941,268

(22) Filed: Nov. 8, 2010

Related U.S. Application Data
(60) Provisional application No. 61/258,995, filed on Nov. 6, 2009.

(51) Int. Cl. G06F 13/10

(52) U.S. Cl. 710/63

(57) ABSTRACT

A USB intermediate device, such as a switch, selectively interconnects computers and console peripherals. The computers are connected via a single USB 3.0 connector. Alternatively, the USB intermediate device selectively shares a peripheral among multiple USB 3.0 connected computers that are in a peer-to-peer session. In yet another alternative, the USB intermediate device combines a charging current from multiple USB 3.0 connected computers and can charge a device with the combined charging current.

### REFERENCE TO RELATED APPLICATION

This application claims the benefit of U.S. Provisional Application No. 61/258,995 filed 6 Nov. 2009, which is incorporated herein by reference.

### BACKGROUND

1. Field of the Invention

This technology relates to sharing of peripherals via a USB 3.0 based intermediate device.

2. Description of Related Art

As computers are more prevalent, it becomes common for a computer user to own and manage multiple computers at home and at work. A KVM (keyboard, video, mouse) & peripherals sharing switch allows a person to use one set of computer peripherals (e.g. keyboard, monitor, mouse, speakers, microphone, USB storage, USB camera, fingerprint scanner) to manage multiple computers, thus eliminating the need to purchase and keep separate computer peripherals for each computer.

A traditional KVM & peripherals sharing switch consists of a switching device, which enables each set of computer peripherals to connect to one computer at a time.

For consumer applications, one set of PC peripherals may already be sufficient (number of console modules, M=1). For enterprise applications, multiple sets of monitor, keyboard and mouse may be necessary for one or more users to manage a large number of computers (M>1).

One major problem with the traditional KVM and peripherals sharing switch is that separate video, audio, keyboard, mouse and USB cables are needed to connect each computer to the switch. This increases the production costs of the switch as well as the production costs of the computers. Additionally, because the computer needs to have many interface connectors, the traditional technique limits the form factor of computers that can be connected to KVM and peripheral sharing switch. For instance, it is not possible to connect eBook, smart phone, or PDA to a traditional KVM and peripherals sharing switch because these mobile computers typically do not have a video connector.

Another problem with the traditional KVM and peripherals sharing switch is that there is limited interaction among multiple computers. For instance, we cannot directly copy files from one computer to another computer via the switch.

Another major problem with the traditional KVM and peripherals sharing switch is that only one computer is active at a time. Consequently, the user may have to regularly switch among multiple computers in order to keep track of the status in each computer. The switching process is inconvenient and usually involves human intervention and attention. Even if the switching process is done automatically, the video switching can be taxing and harmful to human eyes and the peripherals switching can be very slow because it may require device attachment detection and bus initialization.

To display video images from multiple computers, the user may alternatively use multiple console modules (i.e. multiple monitors) to control multiple computers; however, this approach defeats the key advantages of KVM & peripherals sharing switch (i.e. hardware cost+space+power savings).

Yet another approach is that the user may use one computer to log on other computers and then manage the other computers. But this requires all the computers to be on the same network complicating security concerns and computer network structure and the first managing computer has to be powered on all the time!

### SUMMARY

Various embodiments of the present technology use a single USB 3.0 cable connecting each computer to the KVM and peripherals sharing switch. The software device drivers in each computer send its video, audio, keyboard, mouse, storage and other traffic to the KVM and peripherals sharing switch by multiplexing the different types of data onto the USB 3.0 cable. Because only a single USB 3.0 cable is needed, the switch can support a wide range of computers, such as eBook, game consoles, PDA and smart phones.

The KVM and peripherals sharing switch manages the USB 3.0 traffic from each computer, identifies the traffic types and processes them separately. For video traffic, the switch combines the video traffic from multiple computers and displays them in a Picture-in-Picture fashion. For storage traffic, the switch arbitrates the read/write requests from multiple computers and ensures the shared storage device appears to be exclusively connected to each computer. The switch also allows peer-to-peer data communication, enabling direct and efficient data transfer among computers.

Some embodiments of a USB intermediate device, include a plurality of computer ports, at least one computer console port, and a USB processor. The plurality of computer ports have USB 3.0 connectors supporting USB SuperSpeed communications. Each of the USB 3.0 connectors is adapted to carry user input and display signals of a computer of a plurality of computers with computing and communication resources. The computer console port is adapted to connect with at least one set of user input and display peripherals. The USB processor selectively interconnects (i) the at least one set of user input and display peripherals connected to the at least one computer console port, and (ii) the plurality of computers connected to the plurality of computer ports.

Some embodiments of a USB intermediate device, include a plurality of computer ports and a USB processor. The plurality of computer ports have USB 3.0 connectors supporting USB SuperSpeed communications. Each of the USB 3.0 connectors is adapted to support a USB 3.0 peer-to-peer session among multiple computers of a plurality of computers. The USB processor selectively creates a packet-based data communication channel between USB SuperSpeed transmit and receive ports of two communicating computers of the plurality of computers.

Some embodiments of a USB intermediate device, include a plurality of computer ports, a USB processor, and a device charging port. The plurality of computer ports have USB connectors. Each of the USB 3.0 connectors is adapted to support a charging current. The USB processor combines the charging current from multiple ports of the plurality of computer ports into a combined charging current. The device charging port supports the combined charging current.

Yet other embodiments are the methods of practicing the disclosed technology, and non-transitory computer readable media with instructions executable by a USB intermediate device to perform methods of practicing the disclosed technology.

### BRIEF DESCRIPTION OF THE DRAWINGS

FIG. 1 is an example configuration of a USB 3.0 processor selectively interconnecting consoles and computers.

FIG. 2 shows an example of the logical connection between USB 3.0 video device driver and USB 3.0 I/O processor.

FIG. 3 is a block diagram of the USB 3.0 I/O processor.

FIG. 4 is a simplified flowchart of the USB 3.0 video device driver.

FIG. 5 shows an example of PIP.

FIG. 6 shows another example of PIP.

FIG. 7 shows an example computer used with the technology, and example console peripherals

### DETAILED DESCRIPTION

Various embodiments are discussed below. In some embodiments, a USB 3.0 switch that allows selective sharing of one or more computer desktops among one or more displays. In other embodiments, a USB 3.0 switch allows selective sharing of storage or other peripherals among USB 3.0 connected computers, whether the shared peripheral is internal to a USB 3.0 connected computer or connected to the USB 3.0 switch. In yet other embodiments, a USB 3.0 switch combines the charging current from multiple USB 3.0 connected computers into a combined charging current, and supports charging a device connected to the USB 3.0 switch with the combined charging current.

Incorporated by reference herein are the USB 2 and 3 Specifications, including Universal Serial Bus 3.0 Specification, Revision 1.0, Nov. 12, 2008, and Universal Serial Bus Specification, Revision 2.0, Apr. 27, 2000, available at http://www.usb.org. As described by the USB specifications, the various USB bus speeds are: SuperSpeed at 5 Gbps, High Speed at 480 Mbps, Full Speed at 12 Mbps, and Low Speed at 1.5 Mbps.

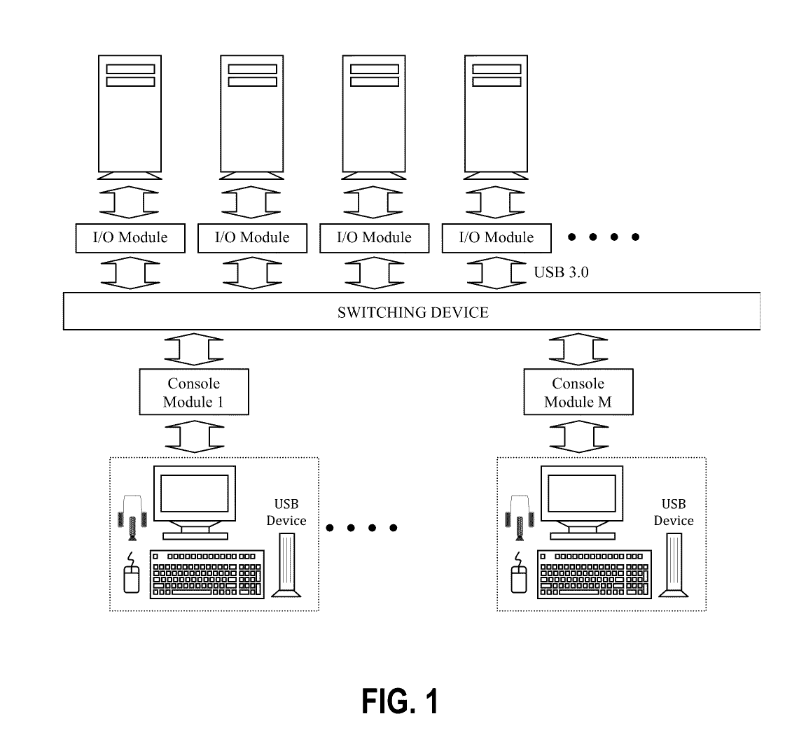

FIG. 1 shows an example configuration. Each host computer is connected to the USB 3.0 based KVM & peripherals sharing switch using a single USB 3.0 cable. Most operating systems already have built-in support for USB-based audio, mouse and keyboard devices. To transmit video signals using USB 3.0 protocol, a USB 3.0 video device driver is installed in every host computer.

In one preferred embodiment of the technology, the USB 3.0 based KVM & peripherals sharing switch includes a USB 3.0 processor. The USB 3.0 processor hardware and firmware architectures are designed to efficiently manage multiple USB 3.0 ports and to effectively process USB 3.0 traffic from multiple computers. Some embodiments include a USB 3.0 video device driver for each host computer. The USB intermediate device can use various types of processor model (e.g. ARM7 or ARM9 processor), bus architecture (e.g. AMBA 2 or AMBA 3 bus), clock speeds, memory sizes (e.g. ROM and RAM sizes), DMA controller type (e.g. register based or scatter/gather), and software interface (e.g. hardware register and interrupt definition).

In other embodiments of the technology, a peer-to-peer USB 3.0 connection among USB 3.0 connected computers, allows sharing of computing and communication resources of the computers. For example, two computers can share the same Internet connection or one computer can use an internal peripheral of another computer. For peer-to-peer communication, the USB 3.0 based KVM creates a packet-based data communication channel connecting USB 3.0 SuperSpeed transmit and receive ports of two communicating computers.

In scenario 1, Computer A has internal HDD A, Computer B has internal HDD B, and the switch is connected to Computer A and Computer B. In this scenario, an internal drive stores the OS and private data. The internal HDD of one computer is accessible via the KVM switch by the other computer. The arbitration and flow control are done mainly in Computer A and Computer B.

In other scenarios, to share a USB 2.0 storage device or USB 3.0 storage device or SATA storage device, a USB 2.0 connection, USB 3.0 connection, or SATA connection is added to the switch.

In scenario 2, the switch is connected to SATA drive, Computer A, and Computer B. This scenario includes an additional USB 3.0 to SATA bridge.

In scenario 3, the switch is connected to USB 3.0 drive, Computer A, and Computer B.

In scenario 4, the switch is connected to USB 2.0 drive, Computer A, and Computer B. Because USB 3.0 is a superset of USB 2.0, scenarios 3 and 4 are very similar.

In scenarios 2, 3, and 4, a shared drive or drives store shared data, such as an office database, etc. Shared drives are also especially useful for data backup. For example, the shared drives in scenarios 2, 3, and 4 can be used to automatically backup data in Computer A, Computer B, etc. In scenarios 2, 3, and 4, the arbitration and flow control are done in the USB 3.0 based KVM.

In other scenarios, another type of storage peripheral connected to the switch is shared, or another non-storage peripheral is shared. USB BOT/Mass Storage Device Class is a useful software device driver for USB storage. However, there are embodiments such as UASP—USB Attached SCSI. Other storage devices (IDE drive aka ATA drive, SATA drive, SCSI drive) do not use USB BOT.

In yet other scenarios, networking is used for data communication. For example, Computer A may be connected to the Internet (or a VPN) via Computer B.

In yet further scenarios, the switch is connected to multiple computers with a USB 3.0 connection, and combines the charging current from each of the multiple computers into a combined charging current, and the switch supports charging a device connected to the USB 3.0 switch with the combined charging current.

BOT (bulk-only-transfer) protocol / Mass Storage USB Device Class accesses USB storage. There is a 3-step handshaking (read or write command, data, acknowledgement) between PC and USB storage. During read or write data transfers, instant switching from one PC to another PC is not possible. Otherwise, PC software (i.e. OS device drivers) will get confused. To support reliable sharing among multiple PCs, an added layer of a flow control state machine and supporting arbitration are used.

The arbitration allows only one machine to exclusively access the storage at any one time (typically for a single read or write transaction).

The arbitration is typically implemented using a software “lock”. Computer A (or Computer B) is required to get a key before data transfer. After obtaining the key, the shared storage is considered “locked” and a locked storage device will always return busy status until the key is returned. The software “lock” is performed at the computer in the case of a shared internal peripheral, and at the switch in the case of a shared peripheral connected to the switch.

The arbitration logic determines which computer shall have access to the shared storage.

The flow control state machine logic ensures that the software (device driver) in each computer shall properly behave. When a computer is using the shared storage, the other computers detect that the storage is temporarily busy. The flow control state machine logic stalls other computers, and allow the “unlocked” computer to continue the operation, such as read or write in the case of storage. The USB flow control mechanism makes the device appear to be temporarily unavailable. As soon as the continuing operation is complete, the flow control state machine logic “unlocks” the “locked” computer (and vice versa), and the newly “unlocked” computer proceeds with its own operation. Each computer “thinks” that it is directly connected to the storage device or other peripheral. The switch-implemented flow control and arbitration logic make the peripheral appear to be connected directly to the computer.

In some embodiments, a memory buffer is included inside the switch.

The following discussion explains embodiments of shared video display via the switch.

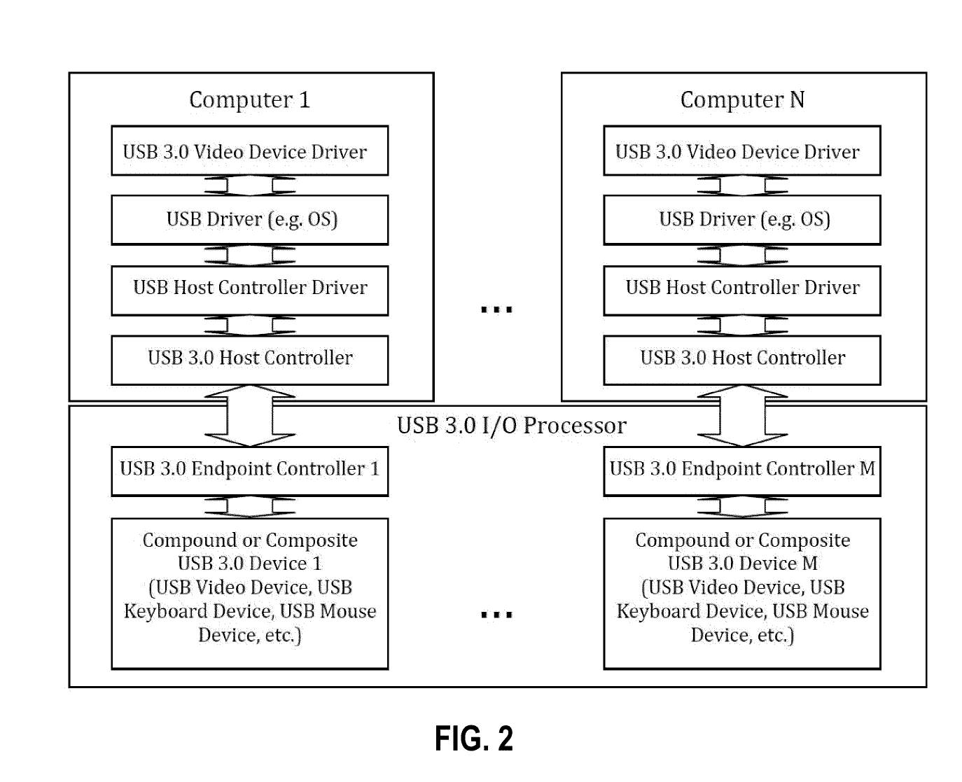

FIG. 2 shows an example of the logical connection between USB 3.0 video device driver and USB 3.0 I/O processor.

Every time the frame buffer of a desktop environment is updated, the USB 3.0 video device driver transmits the changed pixels to the USB 3.0 I/O processor, where the video frame buffer is reconstructed, remixed and displayed. The remixing step supports semi-transparent PIP overlays.

The USB 3.0 video device driver may operate in three different modes:

Standby mode—In this mode, the computer is not connected to any console. As such, the USB 3.0 video device driver simply waits for any connection requests from the KVM & peripherals sharing switch.

Computation intensive mode—In this mode, the computer is connected to a console. The USB 3.0 video device driver is responsible for resizing the desktop image based on the displayed image sizes. The objective is to minimize the USB 3.0 communication traffic. For instance, the desktop resolution may be 1600×1200 pixels and the display resolution (e.g. PIP) may only be 320×240 pixels (4% of the original number of pixels). Thus, the device driver only needs to send very few pixels over USB 3.0 bus. On the other hand, the device driver may need to compute the pixel values using low pass filter or other sampling algorithm to minimize aliasing artifacts.

Communication intensive mode—In this mode, the computer is connected to a console. Unlike computation intensive mode, the hardware (i.e. USB 3.0 I/O processor) is responsible for resizing. The objectives are to reduce the computer processing time and also to allow the same desktop environment to be broadcasted to multiple monitor consoles at different resolutions. The main disadvantage is that the USB 3.0 bus utilization will be higher in this case.

In our technology, the switching device in the KVM & peripherals sharing switch is replaced with a USB 3.0 I/O processor.

On the hardware side, the USB 3.0 I/O processor is responsible for:

Managing every USB 3.0 Endpoint Controller connecting to each Computer

Maintaining every Compound or Composite USB 3.0 Device connecting to each Computer

Connecting the video, audio, mouse, keyboard and USB signals between each Console Module and its selected Computer(s)

Reconstructing, remixing, relocating and resizing the video images (from one or more Computers) for every Console Module

Remixing the audio signals (from one or more Computers) for every Console Module

Generating on-screen display (OSD) for every Console Module

The on-screen display may serve the following purposes:

Allowing the user to manage PIP options

Allowing the user to select which Computer to control

Displaying the user settings, such as monitor orientation (portrait or landscape mode), Computer number, Desktop number, PIP mode settings

Displaying the statistics and alert messages from each Computer, such as CPU usage, disk usage, low disk warnings

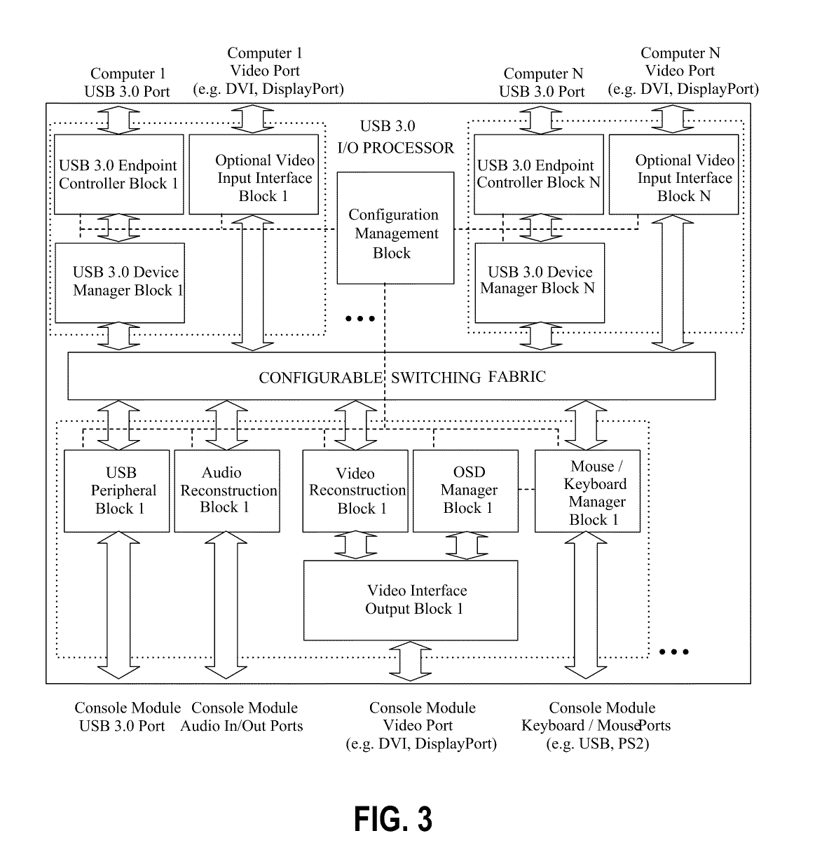

FIG. 3 is a block diagram of the USB 3.0 I/O processor.

Here is a brief description of each block:

USB 3.0 Endpoint Controller Block is responsible for managing the USB 3.0 connection (protocol layer, link layer, physical layer) with the USB 3.0 host controller.

USB 3.0 Device Manager Block is responsible for managing the USB 3.0 composite/compound devices—USB video device, USB audio devices, USB mouse device, USB keyboard device and external USB peripheral device.

Configuration Management Block is responsible for managing all user-defined configurations, such as OSD settings, PIP settings and computer/desktop selection settings. It also maintains the touting table used in Configurable Switching Fabric.

Configurable Switching Fabric is responsible for routing the data packets from USB Device Manager Blocks to the selected Console Modules and vice versa. The routing table is stored in Configuration Management Block. Specifically, the data from USB video device should be routed to Video Reconstruction Block, the data from USB audio devices should be routed to Audio Reconstruction Block, the data from USB mouse and keyboard devices should be routed to Mouse/Keyboard Manager Block, and the data from USB peripheral device should be routed to USB Peripheral Block.

USB Peripheral Block performs as a downstream port in USB 3.0 hub and is connected to an external USB 3.0 device (if available).

Audio Reconstruction Block converts audio packets to audio signals for speaker output and convert audio signals to audio packets for microphone input. It can optionally mix audio signals from multiple computers.

Video Reconstruction Block is responsible for reconstructing the video frame buffer from the selected computer desktop. It is also responsible for superimposing the Picture-in-Picture (PIP) images onto the frame buffer.

Video Interface Output Block combines the video signals from Video Reconstruction Block and OSD Manager Block.

OSD Manager Block is responsible for displaying OSD messages and graphics based on the user settings stored in Configuration Management Block.

Mouse/Keyboard Manager Block detects the mouse and keyboard inputs from the user. Normally, these inputs are routed directly to the selected computer. When a special key sequence (hot key) is entered, the Console Module will enter a special mode allowing the users to change switch settings.

Optional Video Input Block is used if the USB 3.0 device driver is not installed or is inactive on the host computer. The video input is connected directly to Video Interface Output Block in the selected console. Picture-in-Picture (PIP) mode is not supported. This is similar to a traditional KVM & Peripherals sharing switch.

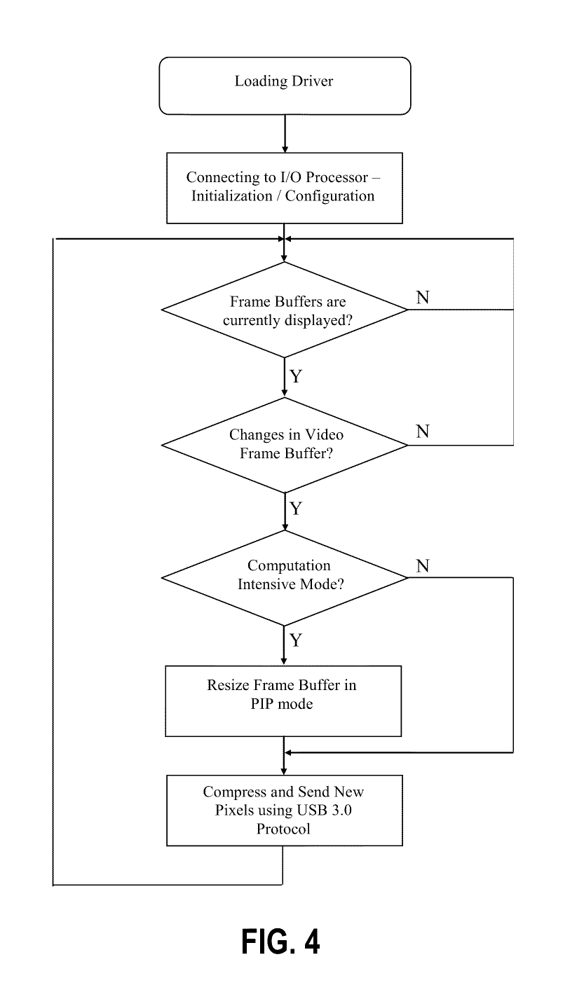

FIG. 4 is a simplified flowchart of the USB 3.0 video device driver.

The video image in each computer can be selectively included in each console monitor in a picture-in-picture (PIP) fashion.

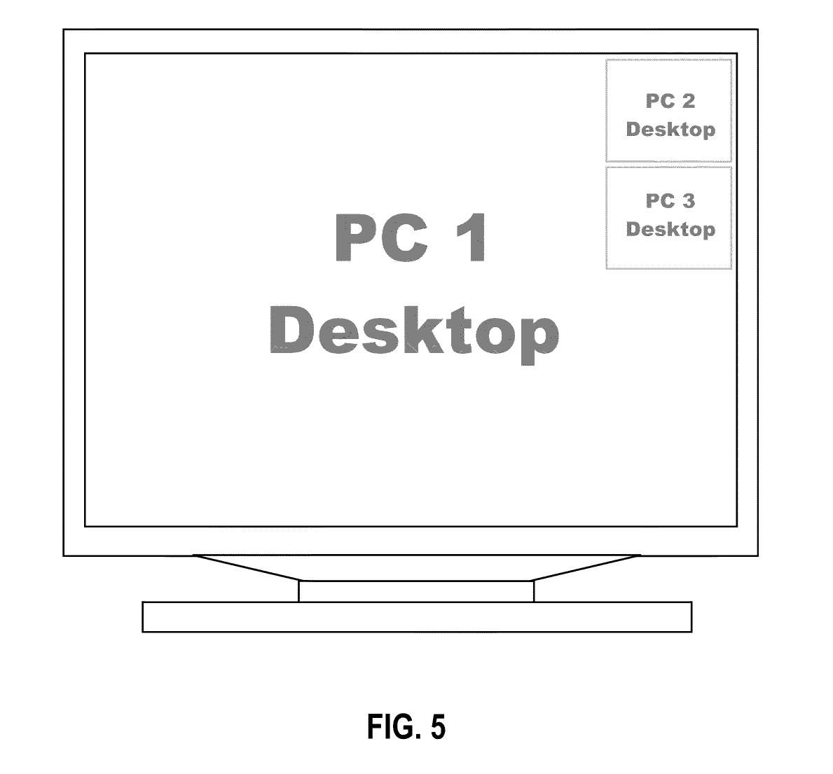

FIG. 5 shows an example of PIP. As a result, the user can easily keep track of two or more computers at any time. The size and location of each PIP can be adjusted based on user configuration. Overlay technique may apply so that each PIP may be opaque or semi-transparent.

Additionally, our technology can reduce the number of cable connections from each computer to the switch. Typically, only a single USB 3.0 cable is used for all PC peripherals. This significantly reduces cable mess and hardware costs.

Unlike the traditional KVM & peripheral sharing switch, our technology can support multiple monitors for each computer. In other words, each computer can display multiple desktop environments even with a single USB 3.0 cable connection.

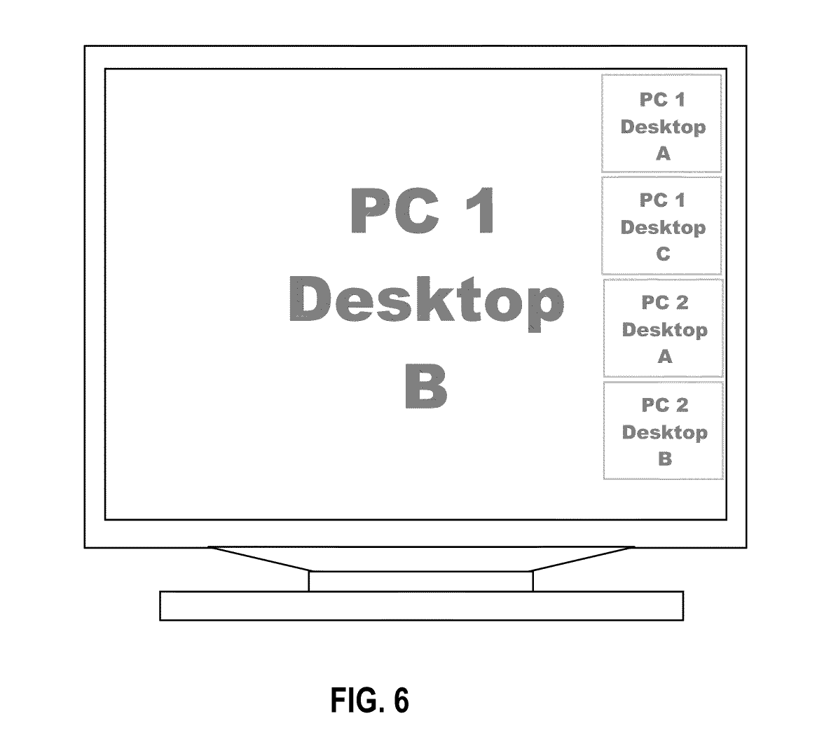

FIG. 6 shows another example of PIP. Each console monitor can be configured to display any desktop environment on its background or in PIP. This feature allows the user to run and manage more applications on each computer.

More advantages of the present USB 3.0 based KVM switch are discussed as follows.

A single display views multiple computers (PCs, cell phones, etc) in full screen mode or in PIP mode. Significantly, multiple computers are actively connected at the same time, such that multiple computers are viewed at the same time and the same storage device appears to be available in multiple computers.

By installing special software in each computer, an object (e.g. file, folder) can be dragged (i.e. copy, move, open) from one machine to another machine.

There are two example embodiments. A more efficient way is to use USB 3.0 peer-to-peer communication that allows direct communication between one PC with another PC using USB 3.0 protocol. A less efficient way is to copy the data from one PC to a memory buffer inside KVM and the data is subsequently copied to another PC.

The peer-to-peer PC-to-PC communication is possible in USB 3.0. USB 2.0 and 1.0 only support master-slave communication-PC is master, storage is slave, etc.

Other embodiments are directed to USB 3.0 power management.

Another advantage of USB 3.0 KVM is that some machines can be in power saving modes (when we want to save power) and easily woken up (when we need to use them).

As an illustration, a PC can be set to hibernate or sleeping mode and its corresponding display (i.e. PIP) may turn gray. Double clicking on the PIP (or otherwise selecting) wakes up the PC. Meanwhile, we can continue to use some other computers. As far as the hibernated PC is concerned, the effect is similar to moving the mouse to wake up the PC.

Waking up a hibernated PC otherwise causes a user to spend time waiting for PC to wake up in this case. Otherwise, the PC may not recognize the mouse/keyboard correctly.

The present USB 3.0 KVM switch can draw power from the USB ports of multiple computers. As an example, suppose we want to charge a power-hungry tablet PC, such as iPad. Today's PC cannot be used to charge an iPad efficiently, because the charging current is very limited (not more than 500 mA). USB 3.0 based PC is better (e.g. 900 mA) but is still not as good as a wall-mounted USB charger (i.e. 2A charging current). The present KVM switch can draw current from multiple USB 3.0 ports (each up to 900 mA). For example, with 3 PC's connected to the KVM switch, we can charge the iPad with up to 2.7A. Other example devices that benefit from such improved charging, are portable devices generally, such as cell phones, PDAs, eBooks, and GPS units that use the switch to charge their batteries. In some embodiments the USB 3.0 KVM switch is a docking station—similar to a laptop docking station for portable devices (such as smart phones e.g. Android phones and iPhones).

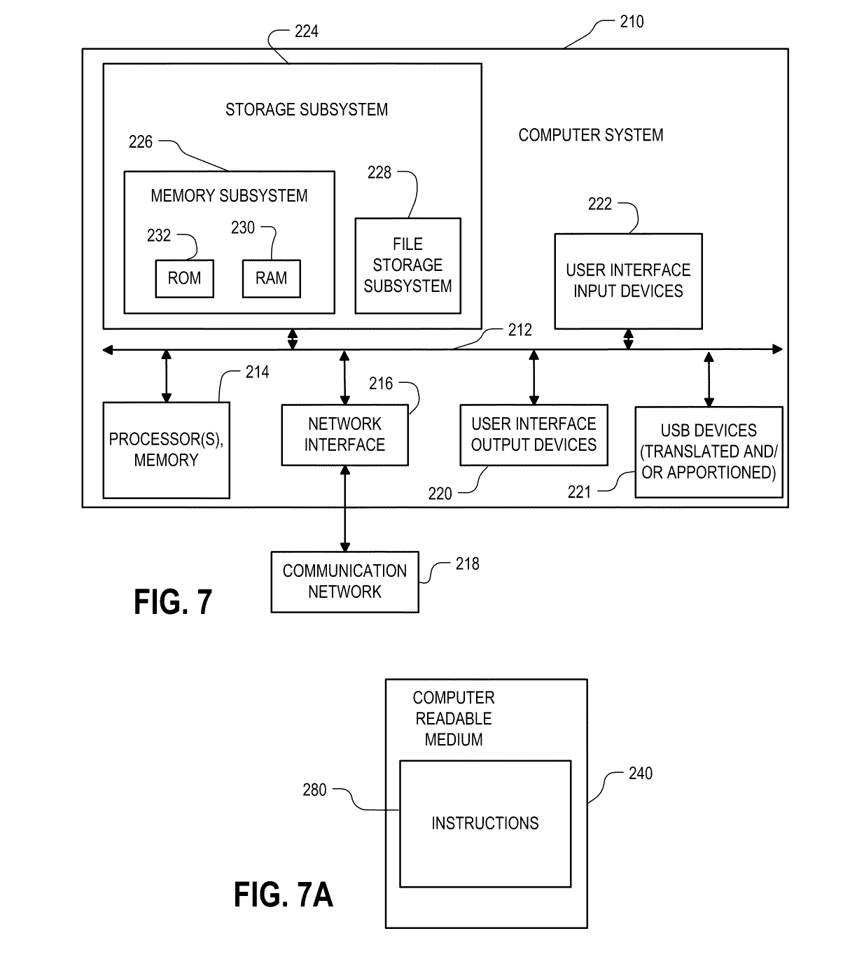

FIG. 7 is a block diagram of an example computer host that works with a USB intermediate device and an example computer readable medium with USB intermediate device code.

Computer system 210 typically includes computing resources such as a processor subsystem 214 which communicates with a number of peripheral devices via bus subsystem 212. These peripheral devices may include a storage subsystem 224, comprising a memory subsystem 226 and a file storage subsystem 228, user interface input devices 222, user interface output devices 220, and communication resources such as a network interface subsystem 216. The input and output devices allow user interaction with computer system 210. Network interface subsystem 216 provides an interface to outside networks, including an interface to communication network 218, and is coupled via communication network 218 to corresponding interface devices in other computer systems. Communication network 218 may comprise many interconnected computer systems and communication links. These communication links may be wireline links, optical links, wireless links, or any other mechanisms for communication of information. While in one embodiment, communication network 218 is the Internet, in other embodiments, communication network 218 may be any suitable computer network.

The physical hardware component of network interfaces are sometimes referred to as network interface cards (NICs), although they need not be in the form of cards: for instance they could be in the form of integrated circuits (ICs) and connectors fitted directly onto a motherboard, or in the form of a single integrated circuit chip with other components of the computer system.

User interface input devices 222 may include a keyboard, pointing devices such as a mouse, trackball, touchpad, or graphics tablet, a scanner, a touch screen incorporated into the display, audio input devices such as voice recognition systems, microphones, and other types of input devices. In general, use of the term “input device” is intended to include all possible types of devices and ways to input information into computer system 210 or onto computer network 218.

User interface output devices 220 may include a display subsystem, a printer, a fax machine, or non visual displays such as audio output devices. The display subsystem may include a cathode ray tube (CRT), a flat panel device such as a liquid crystal display (LCD), a projection device, or some other mechanism for creating a visible image. The display subsystem may also provide non visual display such as via audio output devices. In general, use of the term “output device” is intended to include all possible types of devices and ways to output information from computer system 210 to the user or to another machine or computer system.

USB device subsystem 221 connects to a USB intermediate device as described herein.

Storage subsystem 224 stores the basic programming and data constructs that provide the functionality of certain aspects of the present invention. These software modules are generally executed by processor subsystem 214. The data constructs stored in the storage subsystem 224 also can include any technology files, and other databases. Note that in some embodiments, one or more of these can be stored elsewhere but accessibly to the computer system 210, for example via the communication network 218 or USB devices 221.

Memory subsystem 226 typically includes a number of memories including a main random access memory (RAM) 230 for storage of instructions and data during program execution and a read only memory (ROM) 232 in which fixed instructions are stored. File storage subsystem 228 provides persistent storage for program and data files, and may include a hard disk drive, a floppy disk drive along with associated removable media, a CD ROM drive, an optical drive, or removable media cartridges. The programs 280 implementing the functionality of certain embodiments of the invention may have been provided on a computer readable medium including transitory media, and nontransitory media 240 such as one or more CD-ROMs (or may have been communicated to the computer system 210 via the communication network 218), and may be stored by file storage subsystem 228. The host memory 226 contains, among other things, computer instructions which, when executed by the processor subsystem 210, cause the computer system to operate or perform functions as described herein. As used herein, processes and software that are said to run in or on “the host” or “the computer”, execute on the processor subsystem 214 in response to computer instructions and data in the host memory subsystem 226 including any other local or remote storage for such instructions and data.

Bus subsystem 212 provides a mechanism for letting the various components and subsystems of computer system 210 communicate with each other as intended. Although bus subsystem 212 is shown schematically as a single bus, alternative embodiments of the bus subsystem may use multiple buses.

Computer system 210 itself can be of varying types including a personal computer, a portable computer, a workstation, a computer terminal, a network computer, a television, a mainframe, or any other data processing system or user device. Due to the ever changing nature of computers and networks, the description of computer system 210 depicted in FIG. 7 is intended only as a specific example for purposes of illustrating the preferred embodiments of the present invention. Many other configurations of computer system 210 are possible having more or less components than the computer system depicted in FIG. 7.

Examples of the “Computer” include a Desktop Computer, a Laptop Computer, a Server Computer, a Netbook, a Personal Digital Assistant, a Mobile Internet Device, and a Next Generation Smart Phone.

Examples of the “Console” include one or more USB Ports, one or more monitors, Keyboard, Mouse, Speakers, and/or Microphone. The Console may contain a USB hub with downstream connections to USB mouse, USB keyboard, etc.

Examples of Peripherals connected to USB port are: USB based Camera, USB based Storage Device (e.g. Thumb Drive, Hard Drive, SSD), USB based Display (e.g. DisplayLink at http://www.displaylink.com), USB based Input Devices (e.g. Digitizer, Tablet), USB based MFP (e.g. Printer, Scanner, Fax), USB based Consumer Electronics (e.g. Still Camera, Camcorder, iPOD), and USB based Communication Devices (e.g. Cell Phone).

While the present invention is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the invention and the scope of the following claims.

What is claimed is:

1. An apparatus, comprising:
a USB intermediate device, including:
a plurality of computer ports having USB 3.0 connectors supporting USB SuperSpeed communications, each of the USB 3.0 connectors adapted to carry user input and display signals of a computer of a plurality of computers with computing and communication resources;
at least one computer console port adapted to connect with said at least one set of user input and display peripherals; and
a USB processor selectively interconnecting (i) said at least one set of user input and display peripherals connected to said at least one computer console port, and (ii) the plurality of computers connected to the plurality of computer ports.

2. The apparatus of claim 1, further comprising:
the plurality of computers with processing resources connected to the plurality of computer ports, each computer of the plurality of computers having a USB 3.0 connector connected to a computer port of the plurality of computer ports, via USB 3.0 SuperSpeed communications carrying user input and display signals of said computer.

3. The apparatus of claim 1, further comprising:
said at least one set of user input and display peripherals connected to said at least one computer console port.

4. The apparatus of claim 1, wherein:
said at least one set of user input and display peripherals includes:
a first set of peripherals including a first display showing a first desktop area of the plurality of computers; and
a second set of peripherals including a second display showing a second desktop area of the plurality of computers.

5. The apparatus of claim 1, wherein:
the plurality of computers includes:
a first computer generating a first desktop display signal of a first desktop area of the first computer and a second desktop display signal of a second desktop area of the first computer,
wherein the first desktop display signal and the second desktop display signal are carried via a USB 3.0 cable between the first computer and a port of the plurality of ports; and
said at least one set of user input and display peripherals includes:
a first set of peripherals including a first display showing the first desktop area of the first computer; and
a second set of peripherals including a second display showing the second desktop area of the first computer.

6. The apparatus of claim 1, wherein:
the plurality of computers includes:
a first computer generating a first desktop display signal of a first desktop area of the first computer, wherein the first desktop display signal is carried via a first USB 3.0 cable between the first computer and a first port of the plurality of ports; and
a second computer generating a second desktop display signal of a second desktop area of the second computer, wherein the second desktop display signal is carried via a second USB 3.0 cable between the second computer and a second port of the plurality of ports,
said at least one set of user input and display peripherals includes:
a first set of peripherals including a first display selectively showing the first desktop area of the first computer and the second desktop area of the second computer.

7. The apparatus of claim 6, wherein the first display shows, at a same time, the first desktop area of the first computer and the second desktop area of the second computer.

8. The apparatus of claim 6, wherein the first display shows, at a same time, the first desktop area of the first computer and the second desktop area of the second computer,
such that the second desktop area is a picture-in-picture occupying part of the first desktop area.

9. The apparatus of claim 6, wherein the first display shows, at a same time, the first desktop area of the first computer and the second desktop area of the second computer, and wherein
the second computer comprises a device driver that reduces a display resolution of the second desktop carried via the second USB 3.0 cable.

10. The apparatus of claim 6, wherein the first display shows, at a same time, the first desktop area of the first computer and the second desktop area of the second computer, and wherein
the USB processor reduces a display resolution of the second desktop.

11. The apparatus of claim 1, wherein the USB processor selectively interconnects, via USB SuperSpeed communications, (i) said at least one set of user input and display peripherals connected to said at least one computer console port, and (ii) the plurality of computers with processing resources connected to the plurality of computer ports.

12. The apparatus of claim 1, wherein the USB processor selectively interconnects, via USB SuperSpeed communications and USB 2 communications, (i) said at least one set of user input and display peripherals connected to said at least one computer console port, and (ii) the plurality of computers with processing resources connected to the plurality of computer ports.

13. An apparatus, comprising:
a USB intermediate device, including:
a plurality of computer ports having USB 3.0 connectors supporting USB SuperSpeed communications, each of the USB 3.0 connectors adapted to support a USB 3.0 peer-to-peer session among multiple computers of a plurality of computers; and
a USB processor selectively creates a packet-based data communication channel between USB SuperSpeed transmit and receive ports of two communicating computers of the plurality of computers.

14. The apparatus of claim 13, wherein the peripheral in shared use is an internal storage drive of a computer of the plurality of computers.

15. The apparatus of claim 13, wherein the peripheral in shared use is an internal network connection of a computer of the plurality of computers.

16. The apparatus of claim 13, wherein the peripheral in shared use is connected to the USB intermediate device.

17. The apparatus of claim 13, wherein the USB processor makes the peripheral in shared use appear to be directly connected to each computer of the plurality of computers.

18. The apparatus of claim 13, wherein the USB processor arbitrates among the plurality of computers sharing the peripheral, by allowing one computer of the plurality of computers to access the peripheral, and stalling other computers of the plurality of computers such that the peripheral appears active but temporarily busy to the other computers.

19. An apparatus, comprising:
a USB intermediate device, including:
a plurality of computer ports having USB connectors, each of the USB connectors adapted to support a charging current; and
a USB processor combining the charging current from multiple ports of the plurality of computer ports into a combined charging current; and
a device charging port supporting the combined charging current.

20. The apparatus of claim 19, wherein the device charging port is a USB 3.0 connector supporting USB SuperSpeed communications.

21. The apparatus of claim 19, wherein the device charging port is a USB 2.0 connector supporting USB high speed, full speed and slow speed communications.

22. The apparatus of claim 19, wherein the computer port is a USB 3.0 connector supporting USB SuperSpeed communications.

23. The apparatus of claim 19, wherein the computer port is a USB 2.0 connector supporting USB high speed, full speed and slow speed communications.
